(19) United States
(12) Patent Application Publication
(10) Pub. No.: US 2018/0063278 A1
(43) Pub. Date: Mar. 1, 2018

(54) PROFILE NAVIGATION USER INTERFACE

(71) Applicant: Labelsoft Inc, Plantation, FL (US)

(72) Inventors: Daniel HELLED, Plantation, FL (US); Gal Helled, Plantation, FL (US)

(21) Appl. No.: 15/690,609

(22) Filed: Aug. 30, 2017

Related U.S. Application Data
(60) Provisional application No. 62/381,072, filed on Aug. 30, 2016.

(51) Int. Cl. H04L 29/08; G06F 3/0486; G06F 3/0481; H04L 12/58

(52) U.S. Cl. CPC H04L 67/306; G06F 3/0486; G06F 3/0482; H04L 51/32; G06F 3/04817

(57) ABSTRACT

A system and method for controlling a graphical user interface (GUI), including receiving indications from multiple users about profiles of interest presented to the users by a GUI executed on respective devices of the users, wherein each user has corresponding profile information presentable by the GUI, detecting couples of mutually interested users that indicated each other's profiles as profiles of interest, for each couple, adding in the GUI an anonymous representation of a mutually interested user in a match page of the other mutually interested user, and initiating a discussion between the mutually interested users by opening a discussion page in the GUI, wherein the anonymous representation conceals the represented user's profile from the other user, and once a predetermined condition is fulfilled, changing the anonymous representation to a named representation by loading the profile information of the represented user to the match page.

### RELATED APPLICATIONS

This application claims the benefit of priority under 35 USC §119(e) of U.S. Provisional Patent Application No. 62/381,072, filed on Aug. 30, 2016. The contents of the above application are all incorporated by reference as if fully set forth herein in their entirety.

### FIELD AND BACKGROUND OF THE INVENTION

The present invention, in some embodiments thereof, relates to a social media software application and, more specifically, but not exclusively, to a software application for matchmaking based on selection of user profiles.

Known matchmaking applications and websites base the matchmaking on publically open user profiles, in which users may usually review self-descriptions and/or photos of other users. Based on the open profiles, users decide with which users they want to communicate and/or meet.

The information included in the open profiles is usually of a superficial kind and doesn't enable assessment of the person behind the profile. However, users tend to rely on this information when deciding with which user to communicate and/or meet. Therefore, users of such applications will communicate and/or meet with users who present themselves better in the self-descriptions and look better in the photos, even though they can find more suitable matches among users who seem less attractive based on their profiles.

### SUMMARY OF THE INVENTION

According to an aspect of some embodiments of the present invention there is provided a system for controlling a graphical user interface (GUI), the system comprising a processor configured to execute code for receiving indications from multiple users about profiles of interest presented to the users by a GUI executed on respective devices of the users, wherein each user has corresponding profile information presentable by the GUI, detecting couples of mutually interested users that indicated each other's profiles as profiles of interest, for each couple, adding in the GUI an anonymous representation of a mutually interested user in a match page of the other mutually interested user, and initiating a discussion between the mutually interested users by opening a discussion page in the GUI, wherein the anonymous representation conceals the represented user's profile from the other user, and once a predetermined condition is fulfilled, changing the anonymous representation to a named representation by loading the profile information of the represented user to the match page and/or a chats page.

According to some embodiments of the present invention, the processor is configured to count time, and the condition is lapse of a determined period of time. The length of the period of time is at least one of a list comprising varying dynamically based on predetermined conditions, depending on a number of open discussions a user has with profiles of interest, depending on a sentiment of the discussion and depending on the continuousness of the discussion.

In some embodiments, the processor may be configured to execute code for receiving a request for postponing the profile revealing from a user participating in a discussion and instructing addition of time to the determined period. The processor may be configured to execute code for receiving a response to the request from another user participating in the discussion, and deciding whether to postpone based on the request and response, and instructing addition of time in case of deciding to postpone.

In some embodiments of the present invention, the processor is configured to execute code for enabling an indication of a profile of interest only after a profile page is viewed a predetermined period of time.

In some embodiments of the present invention, the processor is configured to execute code for revealing elements of a profile of interest gradually before the condition is fulfilled. The gradual reveal may be performed in case no discussion is performed between the mutually interested profiles for a predetermined period of time.

In some embodiments of the present invention, the processor is configured to execute code for receiving from a user a request for initiating a discussion with another user whose profile is presented to the user, and initiating a unilateral anonymous discussion with the other user.

In some embodiments of the present invention, the discussion page includes an anonymous Voice-Over Internet Protocol (VOIP) call, and the time left until revealing is reduced faster as the duration of the call is longer.

In some embodiments of the present invention, the discussion page includes indication of time left until revealing of the profiles, and wherein the time left until revealing is reduced faster as the discussion is more active.

In some embodiments of the present invention, the discussion page includes indication of time left until revealing of the profiles, and wherein the discussion page includes a button for requesting postponing of the revealing time, and processor is configured to execute code for changing the indication of time in case the revealing time is postponed.

In some embodiments of the present invention, the discussion page includes indication of time left until revealing of the profiles, and a button for requesting revealing of the profiles before the lapse of the determined period.

In some embodiments of the present invention, the processor is configured to execute code for unsending, editing or resending a message upon a user's request.

In some embodiments of the present invention, the processor is configured to execute code for receiving a request for revealing the profiles from a user participating in a discussion, requesting by the GUI the response of another participating user, and instruct the GUI to reveal the profiles in case both participating users request revealing of the profiles.

In some embodiments of the present invention, the anonymous representation includes an icon representing an unrevealed profile of the other one of the mutually interested users, wherein selection of the icon causes opening of the discussion page at the GUI for discussion between the mutually interested users.

In some embodiments of the present invention, the match page includes additional icons representing unrevealed profiles of other users mutually interested in the device's user, the icons are presented on the match page as a gallery of icons, enabling the user to review all his matches.

In some embodiments of the present invention, the processor is configured to execute code for, once profiles of mutually interested users are revealed, transforming the icon to a profile revealing icon.

In some embodiments of the present invention, the processor is configured to execute code for, adding an anonymous icon of a mutually interested user in a chats page, wherein selection of the icon opens a discussion page at the GUI for discussion between the mutually interested users. The chats page may include additional icons representing unrevealed profiles of other users mutually interested in the device's user, with which a discussion was initiated, the icons are presented on the chats page as a gallery of icons, enabling the user to review all his chats. The processor may be configured to execute code for instructing presentation, in association with the icon, of an indication of a status of the corresponding discussion, the status is with regard to fulfilling of the condition.

In some embodiments of the present invention, the processor is configured to execute code for deciding which profiles to present to the user more frequently based on at least one of a list comprising: user preferences, the profiles users selections, and selections of users with similar mindset.

In some embodiments of the present invention, the processor is configured to execute code for presenting reviewed profiles in two piles of profile cards, one for profiles of interest and one for profiles of no interest, wherein the profiles are ordered in the piles chronologically and the piles enable navigation forward and backward through the profile cards.

In some embodiments of the present invention, the GUI comprises a photo gallery page, the processor is configured to execute code for receiving dragging and dropping commands for placing images in the gallery page, and for selecting a main profile picture by dragging and dropping a selected image into a dedicated position in the photo gallery.

According to some embodiments of the present invention, the processor is configured to execute code for receiving location data from a user's device and for at least one of: presenting to this user profiles according to the location data and offering merchandise or services for sale according to the location data.

According to some embodiments of the present invention, the processor is configured to execute code for interfacing with external social media and controlling via the GUI exposure of elements of a social media profile to a mutually interested user.

According to an aspect of some embodiments of the present invention there is provided a method for controlling a graphical user interface (GUI), the method including receiving indications from multiple users about profiles of interest presented to the users by a GUI executed on respective devices of the users, wherein each user has corresponding profile information presentable by the GUI, detecting couples of mutually interested users that indicated each other's profiles as profiles of interest, for each couple, adding in the GUI an anonymous representation of a mutually interested user in a match page of the other mutually interested user, and initiating a discussion between the mutually interested users by opening a discussion page in the GUI, wherein the anonymous representation conceals the represented user's profile from the other user, and once a predetermined condition is fulfilled, changing the anonymous representation to a named representation by loading the profile information of the represented user to the match page.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system for controlling a graphical user interface (GUI) of a matchmaking software application, according to some embodiments of the present invention;

FIG. 2 is a method for controlling a graphical user interface (GUI) of a matchmaking software application, according to some embodiments of the present invention;

FIGS. 3A-3D are schematic illustrations of pages of a GUI according to some embodiments of the present invention; and

FIG. 4 is a schematic illustration of a photo gallery page of a GUI according to some embodiments of the present invention;

FIG. 5 is a screenshot of an exemplary GUI window indicating mutual interest, according to some embodiments of the present invention;

FIG. 6 is a screenshot of a window having a progress bar according to some embodiments of the present invention; and

FIG. 7 is a screenshot of a profile having a blurred image that is presented during the conversation, according to some embodiments of the present invention.

### DESCRIPTION OF SPECIFIC EMBODIMENTS OF THE INVENTION

Some embodiments of the present invention provide a system and method for controlling a graphical user interface (GUI) of a matchmaking software application that facilitates acquaintance based on an anonymous/semi-anonymous discussion, rather than based on visual properties.

The GUI enables the system to detect mutual interest between subscribers, for example when two users indicated each other's profiles as profiles of interest. In case a mutual interest is detected, the system initiates in the GUI an anonymous communication between the mutually interested profiles.

Optionally, the system enables an anonymous discussion without revealing the discussion's participating profiles until a limited period of time lapses and/or until a certain condition is fulfilled. Once a discussion between two profiles is opened, the system counts time until the period of time lapses.

During an ongoing discussion, the system executes a decision function to decide when to reveal the discussion's participating profiles, for example based on the time lapsed and/or other conditions, such as when revealing requests are received from both participation users. In some embodiments, the reveal timing is set based on the level of activity of the participation users in the discussion, for example, as more messages and replies are detected.

Once the participating profiles are revealed in the GUI, the participating users may review each other's profiles. Thus, the GUI enables a user to have an anonymous/semi-anonymous conversation with a user of interest and thus, for example, to present his personality and to assess the personality of the other user apart from visual properties.

Accordingly, some embodiments of the present invention provide GUI solutions for managing simultaneous discussions with multiple users, for detection of mutually interested users in an initially anonymous manner, and for facilitating anonymous communications between mutually interested users, until certain conditions are fulfilled for revealing their profiles to each other.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some embodiments of the present invention provide a system and method for controlling a graphical user interface of a matchmaking software application. The graphical user interface enables a user of the application to communicate anonymously with another user for a limited period of time and/or until a certain condition is fulfilled. Only when the time lapses and/or a when certain condition is fulfilled, the users can review each other's profiles, for example including photos, videos, self-descriptions, biographical details, and/or any other suitable data. Other suitable data may include but are not limited to, for example, answered questions and/or details filled during profile creation process and/or details filled during use such as religion, hobbies, preferences, and the like. Such user interface may facilitate acquaintance based on personality impressions enabled by the anonymous communications, rather than based on superficial properties.

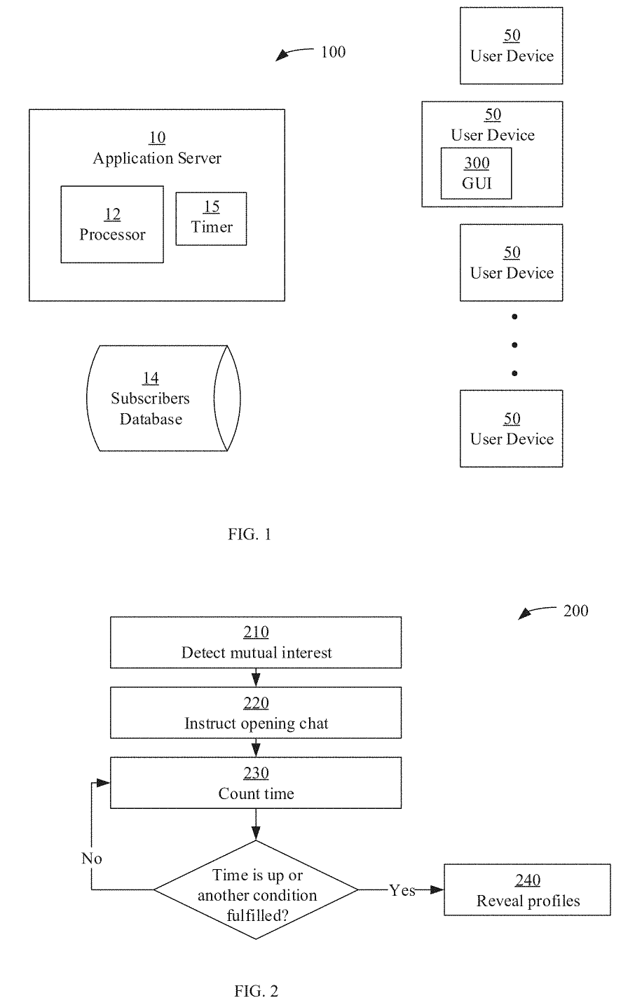

Reference is now made to FIG. 1, which is a schematic illustration of a system 100 for controlling a graphical user interface (GUI) 300 of a matchmaking software application, according to some embodiments of the present invention. System 100 includes an application server 10, having a processor 12, and a subscriber database 14. A plurality of user devices 50 may subscribe to application server 10. The subscription process includes reception of information from a subscribing user and creation of at least one profile page associated with the subscribing user, which may include user's photos, videos, self-description, biographical details, answered questions and/or details filled in the profile creation process, such as religion, hobbies, preferences, and/or any other suitable data. Subscriber database 14 may store, for each subscriber, profile pages data and other subscription details.

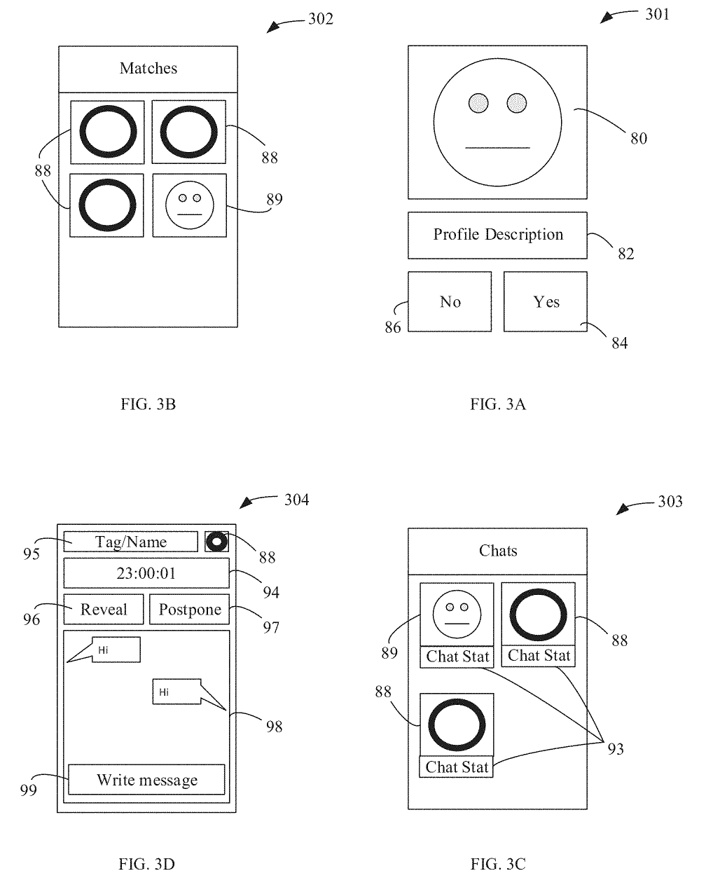

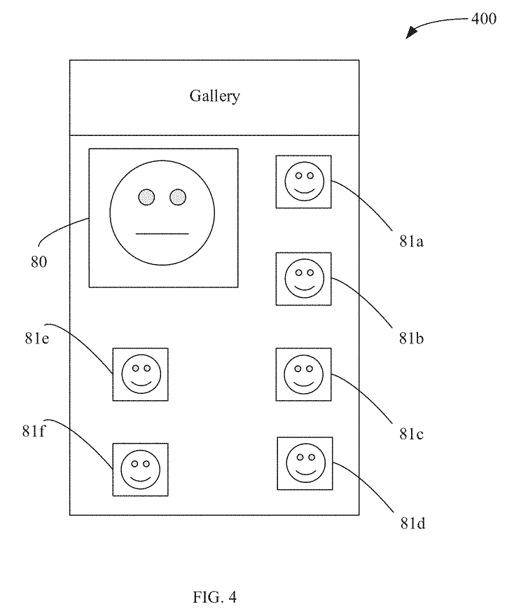

Reference is further made to FIGS. 3A-3D, which are schematic illustrations of pages 301-304 of GUI 300, according to some embodiments of the present invention. During operation, a subscribed user device 50 may execute GUI 300 controlled by application server 10. The user may navigate through profile pages of other users and indicate profiles of interest. In some embodiments, the profiles presented to the user at the navigation stage are selected by processor 12 according to preferences of the user, which are defined by the user at the subscription stage and/or by defining the preferences at the user's profile settings.

A profile of interest may be a profile of a person that the user may potentially want to meet or communicate with. For example, the user may hit a dedicated button when a profile of interest is shown. For example, a profile page 301 shown in FIG. 3A includes a picture 80 of the associated user and a description 82 that may include, for example, self-description and/or biographical details. Profile page 301 may also include links to other pages of the profile, additional photos/videos, and/or any suitable application page. In some embodiments, the profile may include answers to routine questions.

In some embodiments of the present invention, each user has a ranking score based on the user credibility, history of successful matches and/or scores provided by other users and/or according to the user's behavior. The ranking score of the user may be presented in his/her profile page.

In some embodiments, profile page 301 includes buttons 84 and 86 for indication whether the profile interests the user or not, respectively. In other embodiments, one button may suffice for indication that the profile interests the user. In other embodiments, other manners of indication may be used, such as, for example, a swiping motion on a touch screen. In some embodiments of the present invention, buttons 84 and/or 86 become available only after a predetermined period of time such as, for example, a few seconds, for example in order to prevent spamming, i.e. submission of massive amount of positive and/or negative indications without actually reviewing the profiles.

Processor 12 may execute a function to decide which profiles of other users are presented to a certain user more frequently and/or with higher priority, for example based on user pre-defined settings, such as, for example, preferred gender, age, location, and/or any other suitable parameters. In some embodiments of the present invention, when a user marks a reviewed profile of other user as a profile of interest, processor 12 presents his profile to the other user more frequently and/or at higher priority, thus increasing the chance of the other user to find interest in that profile. In some embodiments of the present invention, processor 12 creates clusters of users with similar mindset, i.e. similar interest and preferences, for example based on analysis of each user's interests, preferences, and/or selections of profiles of interest. Processor 12 may decide which profiles of other users are presented to a certain user more frequently and/or with higher priority based on selections of other users with similar mindset.

In some embodiments of the present invention, the reviewed profile pages 301 are presented as cards that can be piled in at least two piles, one for profiles of interest and one for profiles of no interest. For example, profiles of interest to the right and profiles of no interest to the left. The user may be able to review again at a later time a card, i.e. a profile page 301, he placed in a pile. The user may navigate between piled cards, for example by arrow buttons, swiping or any other suitable manner.

Arranging the profiles in the two piles enables a user to better navigate between the profiles. At any time, a user may review the profiles of interest or the profiles of no interest that he marked so far, by simply clicking on the respective pile. The profiles are ordered in the piles chronologically, i.e. in the same order in which they were marked as interesting or not interesting, and the user may navigate forward or backward through the profile cards. In some embodiments, when viewing a profile card, a user may select to undo or change its marking as interesting or not interesting.

According to some embodiments of the present invention, processor 12 may receive GPS location data from the user devices and present profiles to a user according to the user's location. For example, processor 12 may present to a user profiles of users located within a certain distance from the user or within a certain geographical range in which the user is located.

Based on the location data, processor 12 may present to a user profiles of users located within a same building, campus, night club, restaurant and/or any other suitable business or institution. GUI 300 may include features related to a certain locations, which may be activated by processor 12 when the user is in such locations. For example, GUI 300 may enable purchasing of merchandise that may assist in making a match between users. For example, when a conversation reaches a certain time and/or activity limit, a user may purchase beverages, food and/or other suitable merchandise or service offered for sale in the vicinity of the user's location and suggested by GUI 300, for the opposite user in order to promote meeting of the mutually interested users.

Reference is further made to FIG. 2, which is a schematic flowchart illustrating a method 200 for controlling a graphical user interface (GUI) 300 of a matchmaking software application, according to some embodiments of the present invention. As indicated in block 210, processor 12 may detect mutual interest between subscribers. A mutual interest is a condition when two users indicated each other's profiles as profiles of interest. Processor 12 may receive from subscriber devices 50 indications of profiles of interest and store the indications, for example, in database 14. When receiving from a user device 50 an indication of a profile of interest, processor 12 may check whether a mutual interest occurred.

As indicated in block 220, in case a mutual interest is detected, processor 12 instructs initiation of a communication between the mutually interested profiles.

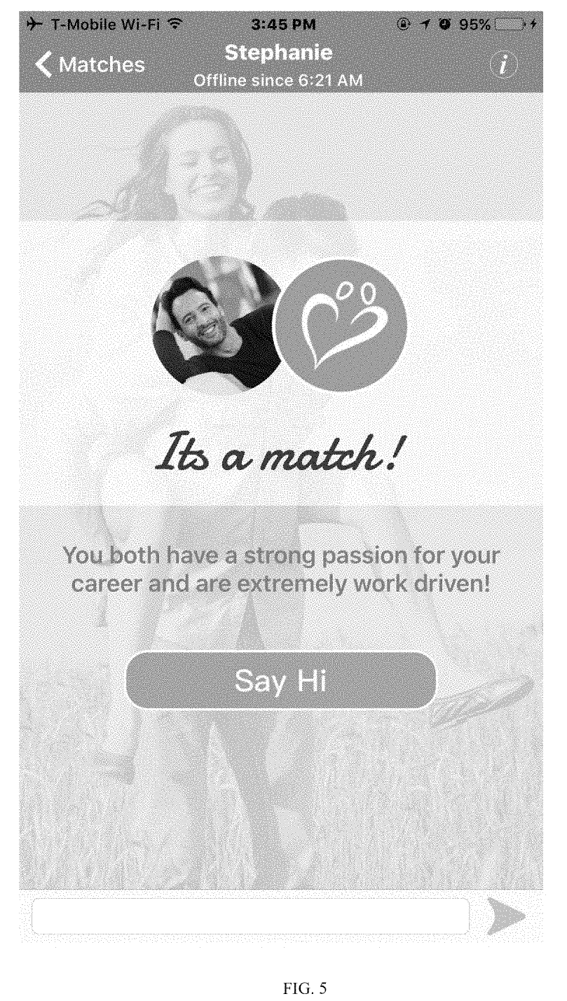

For example, as shown schematically in FIG. 3B, once a mutual interest is detected, a representative icon 88 appears in a matches page 302 of GUI 300, displaying the potential matches. Optionally, a GUI window indicating the mutual interest is presented to the use, for instance as depicted in FIG. 5. Each icon 88 represents an unrevealed profile with which the user has mutual interest, i.e. a potential match. Icons 88 do not reveal the associated profiles of interest. For example, each icon 88 is associated to the respective profile of interest by a tag such as a nickname, thumbnail, code and/or any other suitable tag that doesn't reveal to the user the respective profile. Icons 88 may be presented on matches page 302 as a gallery of icons, by which a user may review all his matches.

As shown schematically in FIG. 3C, a chats page 303 of GUI 300 may present open chats, i.e. conversations that already started with respective profiles, wherein unrevealed profiles represented by icons 88. Page 303 may include, in association with icon 88, an indication 93 of the conversation status, such as time from the beginning of the conversation, time until the respective profile is revealed, responsiveness and/or availability of the respective profile, and/or any other suitable information. Indication 93 may appear, for example, above icon 88, below icon 88, over icon 88, or at any suitable location in association with icon 88. Icons 88 may be presented on chats page 303 as a gallery of icons, by which a user may review all his open chats.

By choosing an icon, for example by clicking on it, touching it or marking it in any other suitable manner, a user may start or continue a conversation with the associated profile. For example, processor 12 receives a selection of an icon and instructs opening a discussion between the user's profile and the profile associated with the selected icon. Accordingly, processor 12 may instruct opening a corresponding discussion page in GUI 300 for facilitating a discussion between the user's profile and the profile associated with the selected icon. Multiple discussions and/or discussion pages may be opened simultaneously, wherein each discussion has a corresponding couple of participating mutually interested profiles, of respective couple of participating users.

A schematic illustration of an exemplary discussion page 304 of GUI 300 is shown in FIG. 3D. As indicated in block 230, once a discussion between two profiles is opened processor 12 starts to count time from the beginning of the discussion, until a period of anonymous discussion time lapses, for example by a timer 15. Processor 12 may enable an anonymous discussion without revealing the discussion's participating profiles for the anonymous discussion period of time, and/or until fulfilling of a certain condition. Discussion page 304 may include a counter 94, showing the time from the beginning of the discussion or the time left until the anonymous discussion period lapses. In some embodiments of the present invention, page 304 may include a counter icon, for example showing the time progress in a graphical manner. For example, counter 94 may be shown when the counter icon is clicked.

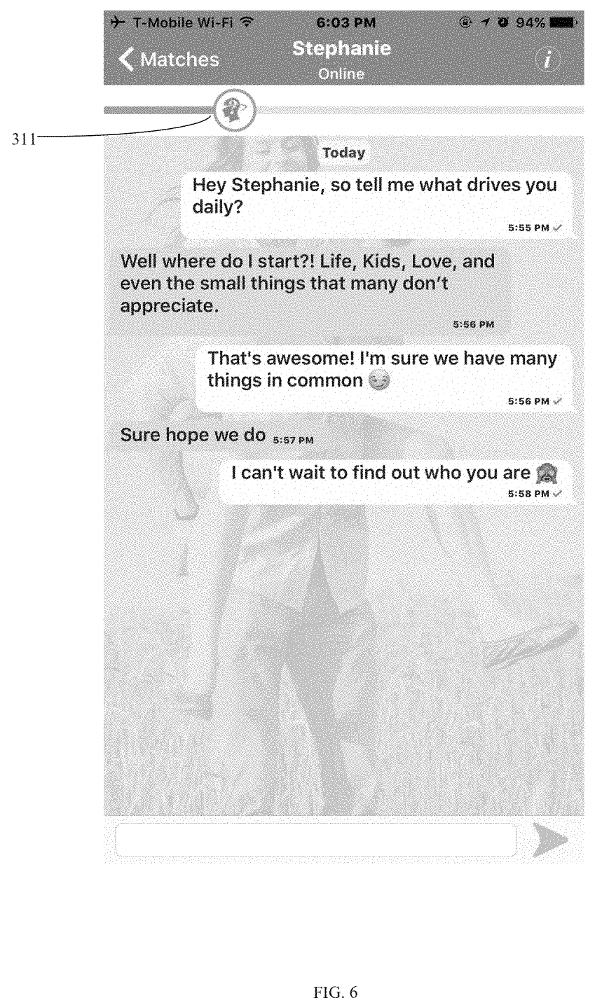

In some embodiments of the present invention, a progress bar is used to present the progress in the conversation in a graphical manner. Optionally, when a conversation starts, a progress bar appears on the top which progresses upon user interaction, for example as depicted by reference numeral 311 in FIG. 6.

Discussion page 304 may include a discussion box 98 showing the discussion, an input field 99 for entering a message. In some embodiments of the present invention, a user may unsend, edit and/or resend a message by request. Unsending a message means removing the message from the other user's discussion page 304. In case a user asks to unsend a message, processor 12 may remove the message from the discussion page and/or hide it from the receiving user. The unsent message may be resent later by the sending user. The unsent message may be edited and the edited message may be resent by the user at any later time. Thus, the user may modify a message before the other user reads it.

In some embodiments, discussion page 304 may enable uploading of attachments, sharing of links and/or live video streaming.

Discussion page 304 may include a tag 95 associating the discussion with the participating profile of interest without revealing the associated profile, such as a nickname, thumbnail, code and/or any other suitable tag that doesn't reveal to the user the respective profile. Additionally or alternatively, discussion page 304 may include a corresponding representative icon 88.

The period of anonymous discussion time may be predetermined, or determined and/or vary dynamically based on various conditions and/or user commands or requests. For example, the period of anonymous discussion time may be predetermined to last 30 days, or any other suitable predetermined period of time. For example, as described herein, in some embodiments of the present invention, once the anonymous discussion period of time, optionally with added postponing time, is up, processor 12 reveals the participating profiles. In some embodiments, the length of the anonymous discussion period of time may depend on the number of open conversations a user has with profiles of interest. For example, in some embodiments, the anonymous discussion period of time is shorter as the number of open conversations is smaller. Another parameter influencing the length of the anonymous conversing time may include, for example, continuousness of conversation. For example, in some embodiments, in case the conversation is more continuous, the length of the anonymous conversing time is shorter.

As used herein, a conversation may be an exchange of information between users during a chat such as an instant messaging chat, a video call or a voice call.

In some embodiments, the reveal is expedited, i.e. the length of the anonymous conversing time is shorter, as the discussion is more active, for example, as more messages and replies take place. For example, whenever a message is sent or received, the anonymous period of time is reduced and the counter is lowered accordingly, in a certain amount of time or percentage of the original period. The reduced amount of time or percentage may be predetermined and/or change dynamically, for example based on previous time reductions and/or overall continuousness/activeness of the discussion or based on other user activities. In some embodiments, the time may be reduced only when a message receives a reply, thus avoiding one-sided massive messaging aiming to expedite the revealing quickly.

In some embodiments, the anonymous period of time may be determined according to the sentiment of the conversation. For example, processor 12 analyzes the terms used in the conversation to assess the sentiments of the users with regard to each other, and change the period of time according to the assessed sentiments. For example, processor 12 reduces the time period in case the assessed sentiments are mutually positive, and/or increases the time period in case the assessed sentiments are mutually negative. For example, the revealing of the profiles may be performed automatically and/or gradually as the sentiments grow more positive.

In some embodiments of the present invention, users may choose to perform the anonymous/semi-anonymous discussion by Voice-Over Internet Protocol (VOIP) call instead of messaging. During a VOIP call a counter 94 may be presented, showing the anonymity time left similarly as in messaging discussion as described herein. In some embodiments, during a VOIP call, the anonymous period of time is reduced faster as the duration of the call is longer.

In some embodiments of the present invention, during conversation, a user may request to postpone revealing of the discussion's participating profiles, for example if more time and/or discussion are needed for assessment of the potential match. Accordingly, page 304 may include a postpone button 97, which a user may use for requesting to postpone the revealing time. In such case, processor 12 may receive the postpone request and add time to the anonymous discussion period of time, for example according to predetermined instructions, user instructions and/or any other suitable parameter. For example, processor 12 may add more time in case both participating users of the conversation request to postpone, and less time if only one of the users requested to postpone. For example, processor 12 may ask each of the participating users of the conversation how much additional time they need, and if the answers are different, add the longer time requested, the shorter time requested, the mean of the two requests, or any other suitable period of time, for example according to predetermined instructions.

In some embodiments of the present invention, once a user asks to postpone, the other participating user may receive a notice. In response, the other participating user may join or not join the postpone request and/or suggest another additional time period.

In some embodiments of the present invention, during conversation, a participating user may request to reveal the discussion's participating profiles before the anonymous discussion period of time lapses. Accordingly, page 304 may include a reveal button 96, which a participating user may use for requesting to reveal the participating profiles. Processor 12 receives the reveal request and, for example, allows revealing of the participating profiles in case reveal requests are received from both participating users. In some embodiments of the present invention, once a participating user asks to reveal the discussion's profiles, the other participating user may receive a notice. In response, the other participating user may join or not join the reveal request.

In some embodiments of the present invention, processor 12 may interface with external social media, for example to control the revealing of profile information on social media external to application server 10 and GUI 300. For example, a user may control via GUI 300 the exposure to a mutually interested user of elements of an associated social media profile, such as a Facebook profile. Such exposure may, for example, be gradual according to the user's selection and/or time, sentiment and/or activity of the discussion between the users, similarly to the various exposure possibilities of profile data from profile page 301.

In further embodiments, content of a user in an external social media, such as photos, posts, and/or profile information, may be presented to a mutually interested user as part of a profile revealing process.

In some embodiments, the postpone and/or reveal buttons may be included in a same box with counter 94 and/or may appear when a counter icon is clicked as described herein above.

Returning to FIGS. 3B and 3C, after a profile is revealed, an icon 88 of the revealed profile may change to a revealing icon 89 that may include the corresponding profile picture, such as picture 80 of the respective profile page 301, full name, and/or any other suitable revealing element. Once icon 88 changes to revealing icon 89, a user may view the respective full profile and/or return to conversation with a revealed profile at any time, for example by clicking on the respective icon 89. The selection process of picture 80 is described in more detail herein below with reference to FIG. 4.

In some embodiments, Processor 12 may start to reveal certain parts of a profile of interest gradually, even before the revealing time. For example, elements of the profile may be revealed gradually and automatically until a full revealing of the profile when the anonymity period is lapsed. For example, an element of the profile are revealed in case the profile of interest appears by an icon 88 in matches page 302 but a discussion is not performed for a long time, for example a predetermined period of time. In some embodiments, the revealed element in each stage may be selected by the user. The gradual revealing may lure a user to start/continue a discussion with this profile of interest.

In further embodiments, a user may request, for example by a dedicated button in discussion page 304, to reveal an element of the profile of the opposite user. Processor 12 may then reveal an element of the profile upon receiving the opposite user's consent. For example, the opposite user may choose which element of the profile will be revealed.

In some embodiments, elements of the profiles may be revealed during conversation in a dedicated region of discussion page 304 and/or in a separate window/page of GUI 300, thus a user may get a glance of the opposite user's profile during conversation.

As indicated in block 240, while a discussion is open, processor 12 may detect conditions for deciding when to reveal the discussion's participating profiles, and reveal the participating profiles once the required conditions are fulfilled.

The conditions may include, for example, the lapsing of the anonymous discussion period of time, optionally with added postponing time, and/or revealing requests from both participation users. Once the participating profiles are revealed, the participating users may review each other's profiles. For example, once the profiles are revealed, a user may recognize the profile of interest and have a more complete impression about the person behind the profile, composed of the impressions formed by the conversation and the profile together.

As indicated above, the conversation may be a voice or video call. In such embodiment, condition may be evaluated by converting speech data into text using a voice to text module and applying functions for evaluating quantity or quality of the conversation on the text.

In some embodiments of the present invention, once the anonymous discussion period of time lapses, or when both users request to reveal the profiles, processor 12 may present a notification in GUI 300, for example on discussion page 304 in both users' devices, that the users may now view each other's profiles. Additionally or alternatively, processor 12 may remove counter 94 from page 304, and/or from any other location in GUI 300 in which a counter of the anonymous period of time is presented in relation with these mutually interested users. As mentioned herein, once the participating profiles are revealed, icon 88 changes to revealing icon 89, and a user may view the respective profile page 301 and/or return to conversation with a revealed profile at any time, for example by clicking on the respective icon 89.

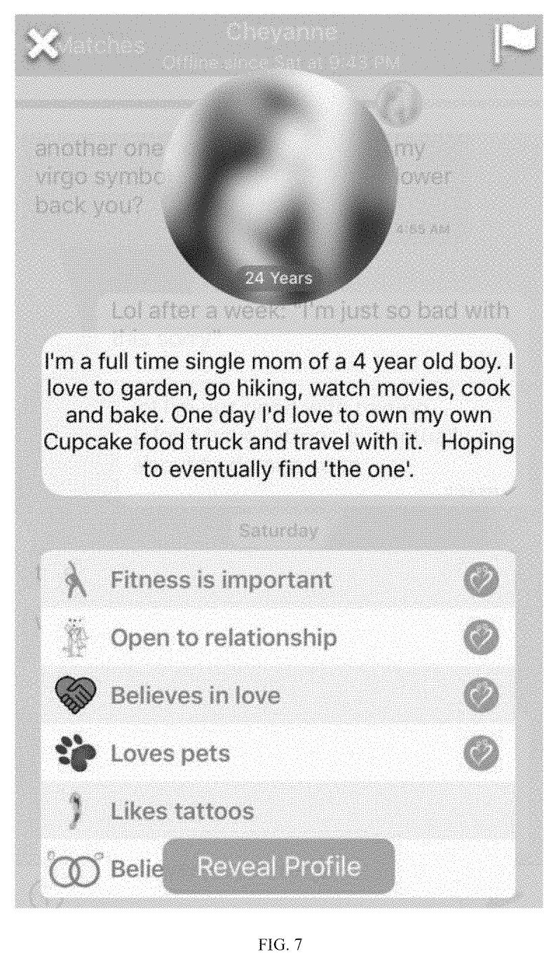

In some embodiments of the present invention, a masked profile image of one or more of the users is iteratively unmasked, namely clarified, for instance reduced in the level of blurring and/or filtering, for instance by changing a weight in a blurring or filtering function that is applied on a version of the profile image which is presented to the users during conversation. The unmasking or clarifying iterations may be held every period and/or based on progress of in the conversation, progress which may be estimated based on compliance with one or more predetermined conditions as described herein. For instance, FIG. 7 is a screenshot of a profile having a blurred image that is presented during the conversation, before it was deburred. Optionally, the blurred image is used as a graphical object indicative of progress in the progress bar.

As indicated above, the conversation may be a video call. In such an embodiment, the video feed may be iteratively deburred or otherwise clarified during the conversation, based on the time that elapses and/or fulfillment of conditions as described herein. When a video call is initiated, the video frames will be blurred and pixilated in the same rate as the profile image is at. For example, when the profile image is already 50% clear, the video frames will also be 50% clear. Optionally, the more users interact through call, the more the progress bar progresses and the clearer the video frames are.

In some embodiments of the present invention, a user may start a conversation with a profile the user encounters while navigating through profile pages of other users. While viewing a profile page, a user may start a named conversation, i.e. a conversation between revealed profiles. In some embodiments, a user may start a unilateral anonymous conversation while viewing a profile, in which the starting user's profile is not revealed to the user of the viewed profile. In a unilateral anonymous conversation, the conditions for the anonymous conversing time period and/or the reveal and/or postpone requests may apply for both or one of the users. In some embodiments of the present invention, if a user doesn't want other users to start unilateral anonymous conversations with him, the user may disable this possibility in his profile settings.

In some embodiments of the present invention, a user has to request to start a unilateral anonymous conversation with a viewed profile, and/or cannot start the conversation without permission from the user of the viewed profile. For example, once receiving a request for a unilateral anonymous conversation, processor 12 asks for permission from the user of the viewed profile. In some embodiments, the request is sent with an initial message from the starting user, and processor 12 sends the message to the user of the viewed profile along with the request for permission and, for example, with the ranking score of the requesting user. In some embodiments, in case permission is not given, the starting user and/or the user of the viewed profile may request for a named discussion with both profiles revealed.

In some embodiments of the present invention, once a unilateral anonymous discussion is opened, the discussion is added to chats page 303 of the starting user and/or the user of the viewed profile.

In some embodiments of the present invention, GUI 300 may enable a user to request a discussion with any suitable user that meets the user's preferences. In response to such request, processor 12 chooses a suitable user among the online users, and initiates an anonymous discussion between the requesting and the chosen user. Such anonymous discussion may be performed according to any of the manners described herein above. In some embodiments, the chosen user may receive a notice before the initiation of the discussion and accept or decline the anonymous discussion. For example, processor 12 may provide the notice together with information about the requesting user, for example the profile's ranking score, which facilitates a decision whether to accept or decline the discussion.

As indicated above, a progress bar may indicate a progress in the discussion. When the bar progresses, information about the users is gradually revealed as indicated above. Such information may include answers to profile questions, biography text, age, and other profile information provided by the user. Additionally or alternatively, the more the bar progresses the clearer the profile image(s) will become clearer, making the profile image less and less pixelated as users interact. In use, the more users chat and interact, the more the bar progresses while the profile(s) of the user(s) is revealed gradually. Optionally, when the bar reaches to a predefined stage, users have the ability to request to reveal each other. Optionally, while a male user has the ability to send a reveal request, a female user has the ability to reveal immediately the profile without any waiting period. This gives female users a control to decide when to actually reveal profiles based on impression and trust increased throughout the conversation.

Reference is now made to FIG. 4, which is schematic illustration of a photo gallery page 400 of GUI 300, according to some embodiments of the present invention. A user may select main profile picture 80 and regular profile pictures 81a-81f from his/her uploaded/existing photos in his/her device and/or in GUI 300. A user may manage his photo gallery page 400 by dragging and dropping images into their respective desired positions in the gallery, in case a previous picture is already in the desired position when a selected picture is dropped in it, the previous picture is transferred to the next position in the gallery.

In some embodiments, in gallery page 400, the selected main profile picture, e.g. picture 80, appears larger than the regular uploaded profile pictures 81a-81f. Picture 80 may be selected by dragging one of photos 81a-81f and dropping it in a position in page 400 dedicated for the main profile picture, in which the selected profile picture is shown larger than the other regular gallery photos. In some embodiments of the present invention, in case a previous picture is already in the profile picture position when a new selected picture is dropped in it, the previous picture is transferred to the next position in the gallery and transformed to a regular size, i.e. the size of the other photos 81a-81f.

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for controlling a graphical user interface (GUI), the system comprising a processor configured to execute code for:
receiving indications from multiple users about profiles of interest presented to the users by a GUI executed on respective devices of the users, wherein each user has corresponding profile information presentable by the GUI;
detecting couples of mutually interested users that indicated each other's profiles as profiles of interest;
for each couple, adding in the GUI an anonymous representation of a mutually interested user in a match page of the other mutually interested user, and initiating a discussion between the mutually interested users by opening a discussion page in the GUI, wherein the anonymous representation conceals the represented user's profile from the other user; and
once a predetermined condition is fulfilled, changing the anonymous representation to a named representation by loading the profile information of the represented user to the match page.

2. The system of claim 1, wherein during the discussion a masked image of at least one of the mutually interested users is presented to the other of the mutually interested users; wherein the masked image is gradually unmasked based on a compliance with at least one predetermined condition or time.

3. The system of claim 1, wherein the discussion is held in a video call established between the mutually interested users; wherein during the discussion the video feed presented to the mutually interested users is masked; wherein the video call is analyzed by an audio analysis to determine a compliance with at least one predetermined condition; wherein the profile information is gradually unmasked based on the determined compliance.

4. The system of claim 1, wherein the discussion is held in a video call or an audio call established between the mutually interested users; wherein the masked video feed is gradually unmasked based on a compliance with at least one predetermined condition or time.

5. The system of claim 1, wherein the processor is configured to count time, and the condition is lapse of a determined period of time; wherein the length of the period of time is at least one of a list comprising varying dynamically based on predetermined conditions, depending on a number of open discussions a user has with profiles of interest, depending on a sentiment of the discussion and depending on the continuousness of the discussion.

6. The system of claim 2, wherein the processor is configured to count time, and the condition is lapse of a determined period of time; wherein the processor is configured to execute code for receiving a request for postponing the profile revealing from a user participating in a discussion and instructing addition of time to the determined period.

7. The system of claim 4, wherein the processor is configured to execute code for receiving a response to the request from another user participating in the discussion, and deciding whether to postpone based on the request and response, and instructing addition of time in case of deciding to postpone.

8. The system of claim 1, wherein the processor is configured to execute code for revealing elements of a profile of interest gradually before the condition is fulfilled.

9. The system of claim 8, wherein the gradual reveal is performed in case no discussion is performed between the mutually interested profiles for a predetermined period of time.

10. The system of claim 1, wherein the discussion page includes an anonymous Voice-Over Internet Protocol (VOIP) call, and the time left until revealing is reduced faster as the duration of the call is longer.

11. The system of claim 1, wherein the discussion page includes indication of time left until revealing of the profiles, and wherein the time left until revealing is reduced faster as the discussion is more active.

12. The system of claim 1, wherein the discussion page includes indication of time left until revealing of the profiles, and a button for requesting revealing of the profiles before the lapse of the determined period.

13. The system of claim 1, wherein the anonymous representation includes an icon representing an unrevealed profile of the other one of the mutually interested users, wherein selection of the icon causes opening of the discussion page at the GUI for discussion between the mutually interested users.

14. The system of claim 13, wherein the match page includes additional icons representing unrevealed profiles of other users mutually interested in the device's user, the icons are presented on the match page as a gallery of icons, enabling the user to review all his matches.

15. The system of claim 1, wherein the processor is configured to execute code for, adding an anonymous icon of a mutually interested user in a chats page, wherein selection of the icon opens a discussion page at the GUI for discussion between the mutually interested users wherein the chats page includes additional icons representing unrevealed profiles of other users mutually interested in the device's user, with which a discussion was initiated, the icons are presented on the chats page as a gallery of icons, enabling the user to review all his chats.

16. The system of claim 1, wherein the processor is configured to execute code for deciding which profiles to present to the user more frequently based on at least one of a list comprising: user preferences, the profiles' users selections, and selections of users with similar mindset.

17. The system of claim 1, wherein the processor is configured to execute code for presenting reviewed profiles in two piles of profile cards, one for profiles of interest and one for profiles of no interest, wherein the profiles are ordered in the piles chronologically and the piles enable navigation forward and backward through the profile cards.

18. The system of claim 1, wherein the GUI comprises a photo gallery page, the processor is configured to execute code for receiving dragging and dropping commands for placing and rearranging image positions within the photo gallery page, and for selecting a main profile picture by dragging and dropping a selected image into a dedicated position within the photo gallery page.

19. The system of claim 1, wherein the processor is configured to execute code for receiving location data from a user's device and for at least one of: presenting to this user profiles according to the location data, offering merchandise or services for sale according to the location data, and interfacing with external social media and controlling via the GUI exposure of elements of a social media profile to a mutually interested user.

20. A method for controlling a graphical user interface (GUI), the method comprising:
receiving indications from multiple users about profiles of interest presented to the users by a GUI executed on respective devices of the users, wherein each user has corresponding profile information presentable by the GUI;
detecting couples of mutually interested users that indicated each other's profiles as profiles of interest;
for each couple, adding in the GUI an anonymous representation of a mutually interested user in a match page of the other mutually interested user, and initiating a discussion between the mutually interested users by opening a discussion page in the GUI, wherein the anonymous representation conceals the represented user's profile from the other user; and
once a predetermined condition is fulfilled, changing the anonymous representation to a named representation by loading the profile information of the represented user to the match page.
